(19) United States
(12) Patent Application Publication
(10) Pub. No.: US 2026/0352581 A1
(43) Pub. Date: Nov. 5, 2026

(54) LINK ADAPTATION ENHANCEMENTS FOR HIGH-MOBILITY WIRELESS STATIONS

(71) Applicant: GM GLOBAL TECHNOLOGY OPERATIONS LLC, Detroit, MI (US)

(72) Inventors: Azin NEISHABOORI, Plymouth, MI (US); Lakshmi V. THANAYANKIZIL, Troy, MI (US)

(21) Appl. No.: 19/181,753

(22) Filed: Apr. 17, 2025

(51) Int. Cl. H04L 43/0823; H04W 64/00; H04W 74/0816; H04W 84/12

(52) U.S. Cl. CPC H04L 43/0847; H04W 64/006; H04W 74/0816; H04W 84/12

(57) ABSTRACT

A first network device includes a physical layer module configured to transmit packets to and receive packets from a second network device via a wireless medium in a wireless local area network (WLAN). The first network device is moving at a speed greater than 3 km/hr relative to the second network device. A media access control (MAC) module includes a link adaptation module configured to selectively identify Doppler-induced degradation in packets received from the second network device based on at least one of a packet error rate (PER), a carrier frequency offset (CFO), a residual CFO, and an indicator of low channel coherence time. In response to the identifying the Doppler-induced degradation, selectively send a first frame to the second network device including a recommended action to mitigate the Doppler-induced degradation.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to wireless networks, and more particularly to link adaptation for high-mobility wireless stations.

Some vehicles may include a wireless station that is configured to communicate with another wireless station (e.g., an access point) that is stationary. The wireless link may be adversely impacted by the relatively high speed of the vehicle relative to the stationary access point. Since the access point typically has a relatively small coverage range, the wireless station in the vehicle also needs to roam from one access point to another to maintain coverage.

### SUMMARY

A first network device includes a physical layer module configured to transmit packets to and receive packets from a second network device via a wireless medium in a wireless local area network (WLAN). The first network device is moving at a speed greater than 3 km/hr relative to the second network device. A media access control (MAC) module includes a link adaptation module configured to selectively identify Doppler-induced degradation in packets received from the second network device based on at least one of a packet error rate (PER), a carrier frequency offset (CFO), a residual CFO, and an indicator of low channel coherence time. In response to the identifying the Doppler-induced degradation, selectively send a first frame to the second network device including a recommended action to mitigate the Doppler-induced degradation.

In other features, the recommended action includes adoption of one or more recommended parameters selected from a group consisting of a number of data symbols in a frame, a request for midamble inclusion, a midamble period, a request for use of Space-Time Block Code (STBC), a number of pilot tones in data symbol, and a number of null tones interleaved between consecutive tones in a data symbol to reduce inter-carrier-interface.

In other features, the first frame further comprises at least one of a velocity, direction, and acceleration of the first network device. The recommended action includes adoption of one or more recommended parameters consisting of an aggregate MAC protocol data unit (A-MPDU) size for the second network device. The recommended action includes adoption of one or more recommended parameters consisting of a transmission opportunity (TXOP) duration for the second network device.

In other features, the recommended action is for the second network device to send one or more frames to the first network device, wherein at least one of the one or more frames enables the first network device to estimate one or more parameters of a WLAN channel used by the second network device to send frames to the first network device. The one or more frames from the second network device include a second frame informing the first network device of a third frame.

In other features, the link adaptation module is further configured to, in response of receiving the third frame, generate a fourth frame including the one or more parameters of the WLAN channel, and send the fourth frame to the second network device after a short interframe spacing (SIFS) amount of time from receipt of the third frame. The link adaptation module is configured to detect the Doppler-induced degradation and to selectively generate the first frame with the recommended action in response to a request from the second network device.

In other features, the device is physically integrated with hardware and software components of a vehicle.

In other features, a method for improving link adaptation between a first network device and a second network device includes selectively identifying Doppler-induced degradation in packets received from the second network device over a WLAN link established between the first network device and the second network device based on at least one of a velocity of motion of the first network device, a packet error rate (PER), a carrier frequency offset (CFO), a residual CFO, and an indicator of fast channel variation. In response to the identifying of the Doppler-induced degradation, selectively sending a first frame to the second network device including a recommended action for the second network device to mitigate the Doppler-induced degradation.

In other features, the recommended action includes adoption of one or more recommended parameters selected from a group consisting of a number of data symbols in a frame, a request for midamble inclusion, a midamble period, a request for use of Space-Time Block Code (STBC), a number of pilot tones in data symbol, a transmission opportunity (TXOP) duration for transmitting frames to the second network device, and a number of null tones interleaved between consecutive tones in a data symbol to reduce inter-carrier-interface.

In other features, the recommended action includes a request for the second network device to send one or more frames to the first network device. In response to receiving at least one of the one or more frames, estimating one or more parameters of a WLAN channel used by the second network device to send frames to the first network device.

In other features, the one or more frames from the second network device include a second frame informing the first network device of a third frame. In response of receiving the third frame, the method includes generating a fourth frame including one or more parameters of the WLAN channel and sending the fourth frame to the second network device after a short interframe spacing (SIFS) amount of time from receipt of the third frame. In response to sending the fourth frame, receiving one or more frames from the second network device. At least one of the one or more frames is sent using transmission parameters based at least in part on the one or more parameters of the WLAN channel included in the fourth frame.

In other features, the first network device corresponds to a WLAN access point (AP) and the second network device is a non-access point WLAN Station moving at a speed greater than 3 km/hr relative to the first network device. The second network device corresponds to a WLAN access point (AP) and the first network device is moving at a speed greater than 3 km/hr relative to the second network device.

In other features, the second network device is configured to, upon initiating a roaming process for the first network device to transition from having the WLAN link established to the second network device to establishing a WLAN link to a third network device, send one or more recommended parameters for mitigating Doppler-induced degradation to the third network device.

In other features, the one or more recommended parameters are selected from a group consisting of an indication of fast channel variation, an estimated channel coherence time, a number of data symbols in a frame, inclusion of a midamble, a midamble period, inclusion of a space-time block code (STBC), a number of pilot tones in data symbol, a transmission opportunity (TXOP) duration, and a number of null tones interleaved between consecutive tones in a data symbol.

A wireless network includes a first network device and a second network device that is moving relative to the first network device. The first network device comprises a first physical layer module configured to transmit packets to and receive packets from a second network device via a wireless medium in a wireless local area network (WLAN) over a channel, wherein the second network device is moving relative to the first network device. A first media access control (MAC) module includes a link adaptation module configured to receive at least one of a velocity of the second network device, receive one or more channel parameters estimated at the second network device, and receive one or more recommended transmission parameters selected from a group consisting of a number of data symbols in a frame, inclusion of a midamble, a midamble period, inclusion of a space-time block code (STBC), a number of pilot tones in data symbol, a duration of a transmission opportunity (TXOP), and a recommended number of null tones interleaved between consecutive tones in a data symbol to reduce inter-carrier-interface. The second network device comprises a second physical layer module configured to transmit packets to and receive packets from the first network device via the wireless medium in the WLAN over the channel and a second media access control device configured to determine the one or more recommended transmission parameters by generating one or more channel quality parameters based on the packets received from the first network device. The one or more channel quality parameters are selected from a group consisting of channel coefficients estimated based on processing one or more training symbols, a packet error rate (PER), a fast channel variation indication, a carrier frequency offset (CFO), and a residual CFO (rCFO) from the second network device.

In other features, the first network device selectively transmits a frame to the second network device. The frame is constructed based on a signal received from a third network device from which the second network device roamed from prior to establishing a WLAN link with the first network device. The signal includes one or more of a velocity of the second network device, a channel parameter estimated at the second network device, and a recommended transmission parameter selected from a group consisting of a number of data symbols in a frame, inclusion of a midamble, a midamble period, use of a space-time block code (STBC), a number of pilot tones in data symbol, a duration of a transmission opportunity (TXOP), and a recommended number of null tones interleaved between consecutive tones in a data symbol to reduce inter-carrier-interface. The third network device determined the recommended transmission parameter based on previous data exchanges with the second network device prior to the roaming.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an example of link partners including wireless station A (STA A) (e.g., an access point) and a wireless station (STA B) that is moving relative to STA A according to the present disclosure;

FIG. 2 illustrates an example of STA B roaming from STA A to another station (STA C) according to the present disclosure;

FIG. 3A illustrates an example of link adaptation between STA A and STA B when STA B is moving relative to STA A and the link is adversely impacted by Doppler-induced degradation according to the present disclosure;

FIG. 3B illustrates another example of link adaptation between STA A and STA B when STA B is moving relative to STA A and the link is adversely impacted by Doppler-induced degradation according to the present disclosure;

FIGS. 4 to 8 illustrate examples of methods for performing link adaptation to mitigate Doppler-induced degradation according to the present disclosure; and

FIGS. 9 and 10 illustrates other examples of link adaptation to mitigate Doppler-induced degradation according to the present disclosure.

In the drawings, reference numbers may be reused to identify similar and/or identical elements.

### DETAILED DESCRIPTION

While wireless stations (STAs) according to the present disclosure are described in the context of vehicles connecting to stationary access points (APs), the STAs can be used in other types of networks where there is relative movement between link partners. For example, the STAs can include connectivity-capable devices such as smart phones, personal device assistants (PDAs), laptops, and/or wearables such as smart watches. These STAs may be connected to external APs while onboard a moving vehicle (such as passenger vehicles, buses, trains, etc.). In addition, the present disclosure also applies to situations where the STA and AP are not moving relative to each other, but the wireless medium between them is subject to high channel variations due to movement. For example, both AP and STA may be located in the same vehicle driving along a street. Reflectors, refractors, other vehicles, and/or people are moving relative to the AP and STA and add channel variations experienced by the wireless link between AP and STA.

Wireless networks described herein include wireless stations (STAs) that communicate with each other using 802.11 wireless connectivity protocols such as wireless local area network (WLAN) or Wi-Fi. The link partners configure protocol parameters to optimize the wireless link. For example, a stationary access point (AP) may correspond to STA A and a moving vehicle corresponds to STA B that wirelessly communicates with STA A.

As STA A sends frames to STA B, STA B estimates channel parameters based on received packets from STA A. These parameters comprise channel coefficients, Carrier Frequency Offset (CFO), tracked parameters (e.g., residual Carrier Frequency Offset (rCFO)), and/or channel coefficient variations. Based at least in part on these parameter estimations, and with the help of error correcting mechanisms, STA B attempts to retrieve the data sent by STA A. If STA B fails, the failing packet increases the received Packet Error Rate (PER). STA A becomes aware of PER at the receiver based on an acknowledgement (ACK). That is, if STA A does not receive from STA B an ACK corresponding to a transmitted frame or subframe, STA A determines that frame or subframe transmission failed. Accordingly, STA A may adjust the transmission parameters for future packets to STA B, such as a modulation coding scheme (MCS), number of spatial streams, use/not use of space-time block code (STBC) if STA A has more than one RF chain, and others. The dynamic mechanism is often referred to as link adaptation. Furthermore, STA B may also select one or more recommended parameters based on the estimated channel parameters and the PER within a sliding time window from STA A. After STA B makes these selections, STA B sends a feedback frame including the one or more recommended parameters to STA A.

Many data symbols may be transmitted as part of a single aggregated MAC protocol data unit (A-MPDU) transmission that shares a single physical layer (PHY) preamble. All of the constituent MPDUs (which could contain singular MAC service data units (MSDUs) or aggregate MAC service data units (A-MSDUs)) are sent in a single physical layer convergence procedure (PLCP) protocol data unit (PPDU). Once the PHY parameters are declared in the PHY preamble, the PHY parameters will remain unchanged until the A-MPDU finishes sending all of the subframes.

Current enhanced link adaptation modules allow a receiving STA to recommend (on a solicited or unsolicited basis), inter alia, an MCS, number of spatial streams (NSS), bandwidth (BW), resource unit (RU) allocation recommendations, and other transmission parameters to a transmitting STA based on computation of characteristics of a received PPDU.

Doppler effect can seriously degrade data transmission at the receiver of STA A when STA B is moving quickly (e.g., greater than pedestrian speeds such as 3 kilometers per hour (km/hr)) relative to STA A (or when both are moving). The frequency shift (or Doppler shift) due to the relative movement between link partners results in loss of orthogonality of adjacent subcarriers in transmissions using Orthogonal Frequency Domain Modulation (OFDM), such as those used in 802.11a, g, n, ac, ax, be, and most likely future generations of WLAN. Loss of orthogonality increases PER of frames sent from STA A to STA B. The Doppler shift can be reflected in both of the CFO and rCFO values perceived at the receiving STA.

The Doppler effect also reduces channel coherence time. Channel coherence estimates the duration of time that the channel (and thus the channel coefficients) can be assumed more or less non-varying or highly correlated. Channel coherence is inversely proportional to the value of Doppler shift. In other words, an estimate of the channel condition at time t_0 is rendered useless after a duration equal or greater than t_0+channel coherence time. WLAN PPDUs transmitted for a period longer than the channel coherence time experience higher PERs since the PHY parameters of a single PPDU are determined in the PHY preamble sent at the beginning of the frame. The remaining data symbols transmitted in the PPDU (either as part of one MPDU or in subframes of an aggregate A-MPDU) are transmitted using the same parameters despite the changes in the channel due to Doppler effect.

Current link adaptation mechanisms in WLAN standard do not efficiently account for Doppler effect that may occur when there is fast relative movement between the STAs. After observing a high packet error rate (PER), current link adaptation modules reduce the MCS level until reaching an MCS level that results in lower PER. However, when there is high Doppler, this method is inefficient for at least two reasons: (i) the coherence time of the channel is very small, and thus whatever estimations were made on the condition of the channel based on previous rounds of frame transmissions and (block) acknowledgment receipt (or lack thereof) are rendered invalid after a coherence time duration has passed, and (ii) the error may be due to high CFO, and/or high rCFO and which can be addressed by utilizing a method which could mitigate inter-carrier interference (ICI) impact due to Doppler shift.

In some examples, link adaptation modules enable the receiver at STA B to include an indicator of high CFO/rCFO and/or fast channel variation observed at the receiver of STA B. The link adaptation module of STA B selectively recommends parameters to STA A (from which it received the PPDU). Examples of recommended parameters include: (a) inclusion of a midamble, (b) a midamble period based on the measured level of CFO/rCFO, and/or determination of fast channel variation; (c) an increased number of pilot tones in each data symbol; (d) null tones interleaved between data tones to increase effective subcarrier spacing; (e) reducing the number of data symbols in an MPDU (which is sent singularly or as part of an A-MPDU); (f) reducing the number of subframes in an A-MPDU frame and to be acknowledged by a Block ACK (BACK), (g) adjusting the value of transmission opportunity (TXOP) used by STA A for future transmissions to STA B, and (h) employing STBC if applicable.

In some examples, to aid STA A in selecting PHY parameters to reduce PER in future frame transmissions to STA B, STA B sends to STA A one or more computed metrics such as: estimated channel information (corresponding to different taps of the channel impulse response or corresponding to channel coefficients affecting the reception of data modulated on each subcarrier), instantaneous channel coherence time, average channel coherence time (computed over a sliding window of time, wherein the sliding window is greater than the instantaneous channel coherence time), cross-correlation of channel coefficients obtained from successive received PPDUs, CFO, and/or rCFO (average or instantaneous over a sliding window of time).

STA A receives the feedback from STA B comprising one or more recommendations and/or metric estimations discussed above and uses them to select and configure PHY parameters for future frame transmissions to STA B. For example, upon indication of high PER in transmissions to STA B, STA B provides recommendations and/or metric estimations.

STA A may accordingly adopt the recommended MCS value or determine its own, reduce TXOP value, reduce PPDU length, increase the number of pilot tones in each of the data symbols, include a midamble at a period recommended by STA B (or a different value it deems more conducive to reduce PER), increase the effective spacing between consecutive data tones by the number of null tones sent between every two data tones to mitigate ICI, use of STBC (if STA A has more than one antenna used for transmission) to leverage diversity to improve link robustness, and/or reduce the number of spatial streams. Note that STA A, by reducing the size of PPDU, e.g., by setting up a new block acknowledgement scheme wherein the size of its block acknowledgement (BA) agreement is reduced, can both adapt faster to worsened channel conditions and high PER conditions by creating new PPDU with updated PHY. In some examples, the PPDU may include an extended long range (ELR) PPDU where data is replicated in 4 52-tone RUs in each 20 MHz. Also note that periodical midamble (training) symbols transmitted among data symbols allow the receiver to re-compute channel coefficients (e.g., to improve correct data retrieval capability from the received frame) even if those data symbols all use the same MCS level and other PHY parameters.

In some examples, the speed, direction of motion, and/or acceleration of the vehicle (e.g., hosting STA B) may also be sent in the feedback frame to STA A. In some examples, STA A uses the speed and/or acceleration to select the Doppler mitigation parameters used for frames sent to STA B.

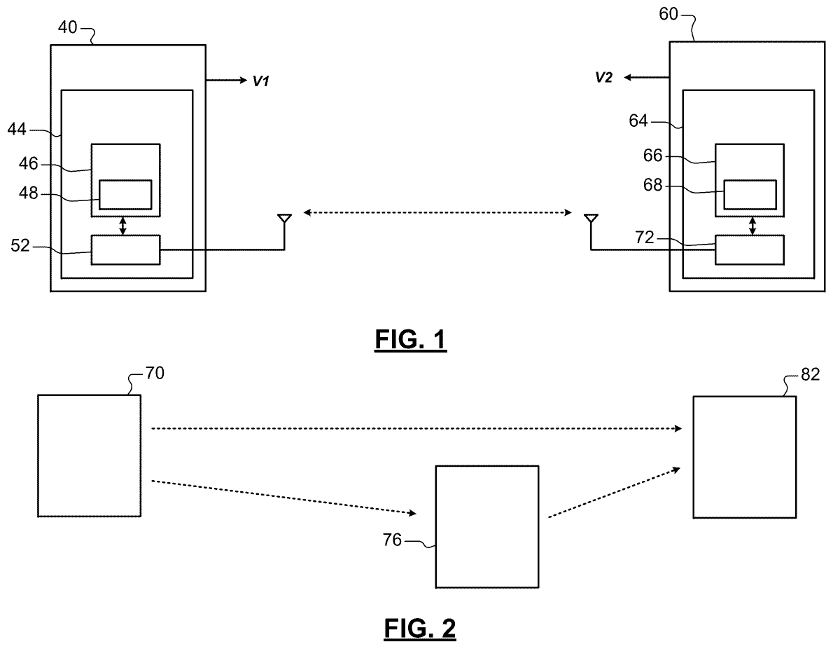

Referring now to FIGS. 1 and 2, examples of link partners are shown. In FIG. 1, a host 40 includes a wireless module 44 (e.g., station A (STA A)) and a host 60 includes a wireless module 64 (or STA B). In some examples, the host 40 is stationary (e.g., access point) and the host 60 is moving (e.g., a vehicle). The wireless module 44 of STA A includes a media access control device 46 including a link adaptation module 48 and a physical layer (PHY) device 52 that transmits/receives data to/from a medium. The wireless module 64 of STA B includes a media access control device 66 including a link adaptation module 68 and a physical layer (PHY) device 72.

When packets are initially sent by a first station (STA) to a second STA, link adaptation is performed by the first STA based on indication(s) received from the second STA on the success/failure rate of the transmission(s). The indication(s) may comprise implicit and/or explicit single or block acknowledgement frame(s), and/or one or more frames transmitted by the second STA to the first STA including recommended transmission parameters for future frames to be transmitted by the first STA to the second STA. However, current link adaptation methods do not adequately address transmission errors that occur due to high mobility including Doppler shift and fast channel variations. Current link adaptation methods do not work effectively in the presence of fast channel variations which occur due to high Doppler spread resulting in low channel coherence time.

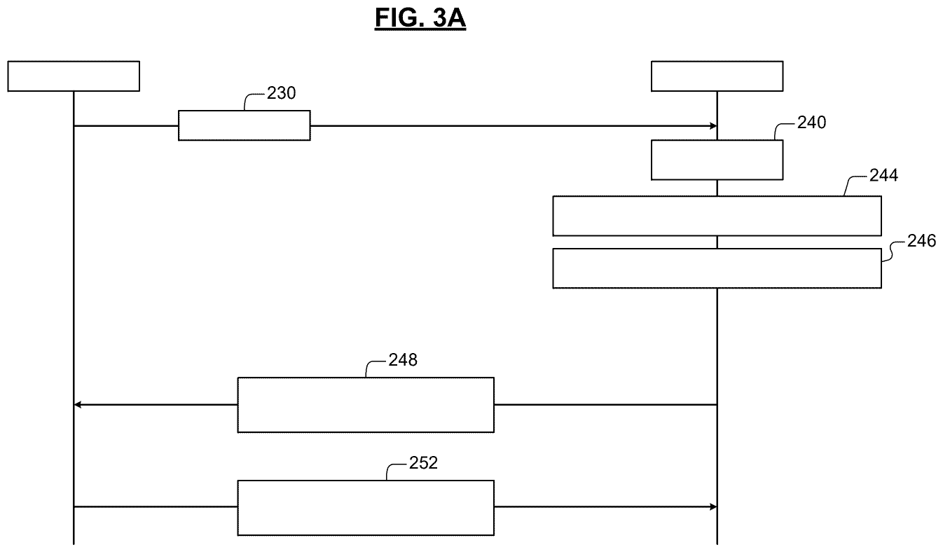

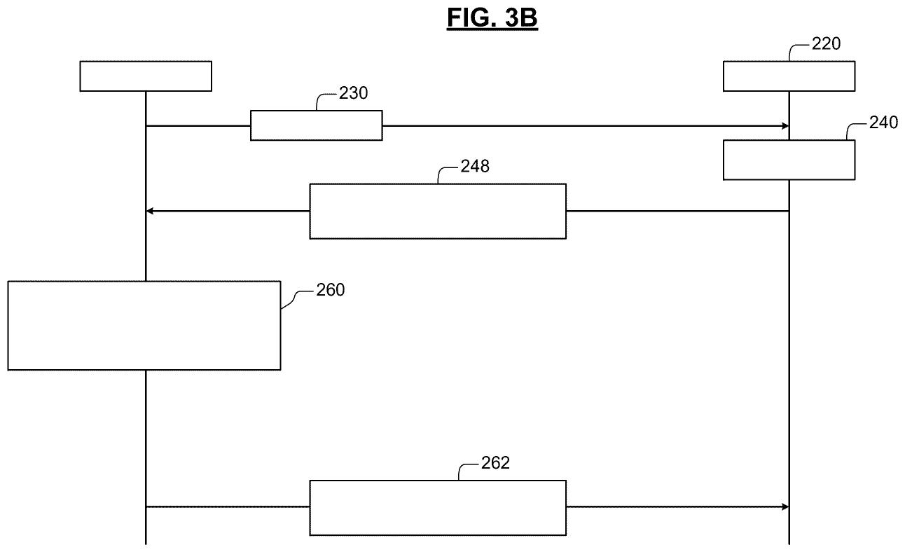

To alleviate these problems, STAs according to the present disclosure perform an improved link adaptation mechanism in response to the Doppler-induced degradation. In FIG. 3A, STA A sends a PPDU at 230 to STA B. STA B uses this transmission to compute statistics on received PER (based on transmission 230 and potentially previous frames received from STA A in a sliding time window of a first predetermined interval, e.g., 1 msec, 5 msec, or 100 msec), CFO and/or rCFO, error vector magnitude (EVM), and other transmission quality indicator metrics at 240.

In an example embodiment, the PPDU sent at 230 to STA B indicates to STA B that it requires a response from STA B within a predetermined period of time. For example, the PPDU sent at 230 may be a null data packet (NDP) which contains only training symbols and no data symbols. STA B, in response to receiving the frame from STA A, may perform channel estimation computations. The packet sent at 230 may be preceded by an announcement packet also transmitted by STA A to prepare STA B for upcoming transmission at 230. Alternatively, the PPDU transmitted at 230 may be a regular frame including data symbols and a preamble. STA B detects whether Doppler-induced degradation is present (e.g., based on high PER, high CFO, and/or high rCFO, and computation of channel coherence time (or another metric highly correlated with channel coherence time) at 244.

The link adaptation module according to the present disclosure reduces the effect of Doppler-induced degradation between the link partners due to fast relative movement of the link partners. In some examples, when Doppler-induced degradation is detected at 244, the link adaptation module of STA B generates a feedback frame at 246 including one or more recommended link adaptation parameters to reduce the impact of the Doppler-induced degradation.

In some examples, the link adaptation parameters recommended by STA B are sent to STA A at 248. STA A adjusts one or more link parameters based on the recommended parameters from STA B to mitigate the Doppler-induced degradation. For example, the link adaptation feedback from STA B may include recommended changes to one or more link parameters selected from a group consisting of midamble inclusion, midamble period, frame length, number of subframes to receive block acknowledgement (BACK), TXOP duration, number of pilot tones to include in each data symbol, and/or adoption of STBC. STA A sends PPDUs to STA B using one or more of the recommended link adaptation parameters to mitigate the Doppler-induced degradation.

For example, frames can initially be sent without a midamble or with a short midamble. When Doppler-induced degradation is detected, STA B optionally suggests midamble inclusion as one of the link adaptation parameters or increases the recommended frequency of midamble transmitted between data symbols. The midamble can be used by STA B to recompute channel coefficients and/or recalibrate according to update values of estimated CFO, which all result in improvement in correct data retrieval and reduced PER.

In other examples, STA B recommends for STA A to reduce the frame length, e.g., by reducing the number of subframes to receive block acknowledgement (BACK), and/or the number of data symbols in each (single or aggregate) frame. STA B may also recommend for STA A to increase the number of pilot tones it includes in each data symbol upon determination of Doppler-induced degradation.

STA A can additionally or alternatively also determine its link adaptation parameters locally (rather than receiving one or more recommended PHY parameters from STA B, or adopting those recommended values) in response to STA B sending one or more of perceived channel parameters, recent (based on a sliding window covering a predetermined amount of time) statistics on channel coherence time, PER, EVM, CFO, and/or RCFO to STA A.

In FIG. 3B, STA B measures those values at 240 based on the PPDU and sends a feedback frame at 248 to STA A (AP) including the measured link parameters. STA A receives the measured and/or estimated link parameters and determines link adaptation parameters described above at 260. STA A sends the next PPDU to STA B using the link adaptation parameters at 262. For example, STA A includes a midamble with a midamble period, reduces the number of data symbols in each PPDU, sets a maximum number of bytes in an A-MPDU (and its subframes), adjusts the MCS scheme to a lower modulation order and code rate, and/or increases the number of pilot tones in each OFDM symbol, selecting from among a set of possible pilot tone numbers in each data symbol.

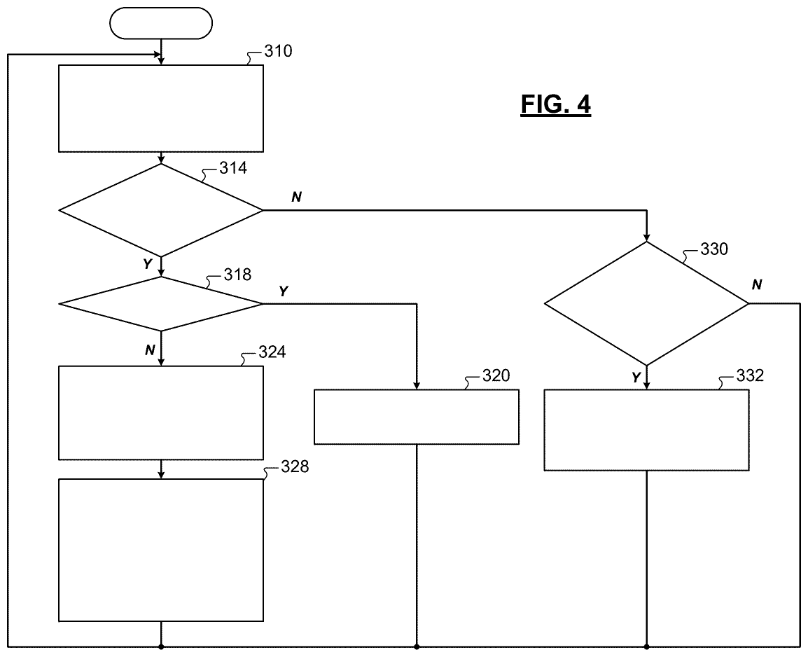

Referring now to FIG. 4, a method for performing link adaptation is shown. At 310, statistics on packet error rate as well as statistics and instantaneous values of course/fine CFO (and/or other channel parameters) are measured at STA B using a PPDU received from STA A, which may be used together with previous values of those metrics to obtain statistical parameters such as mean, median, and standard deviation over a sliding time window of duration T_1. At 314, the method determines whether average PER is greater than a PER threshold (PER_{TH}) and average and/or instantaneous CFO is greater than a CFO threshold (CFO_{TH}). STA B may also use channel coefficients obtained from the LTF and tracked via pilot data, compare them with prior channel coefficient values, to determine fast channel variation. STA B may further update values of statistical parameters on channel coherence time (e.g., its mean and standard deviation) to determine Doppler-induced degradation. Accordingly, in step 314, a comparison may also be made for estimated channel coherence time<CT_threshold, (e.g., CT_threshold=7 msec). Alternatively, instead of estimated channel coherence time, channel coefficients auto-correlation using current and prior values could be used in step 314 to determine Doppler-induced degradation, e.g., channel_correlation<0.5.

If 314 is true, the method continues at 318 and determines whether a midamble is present. If 318 is true, the method turns on a midamble request flag and computes a recommended midamble period based on one or more of |CFO_{TH}−CFO|, estimated channel coherence time, and/or correlation value of the channel coefficients. In some examples, if based on estimated channel coherence time, the midamble period is set to less than or equal to the estimated channel coherence time to ensure channel coefficients are recomputed after the previous channel coefficients are no longer valid (i.e., after channel decorrelates).

At 328, one or more actions are performed. The one or more actions are selected from a group consisting of recommending early TXOP, early A-MPDU termination, including a midamble flag and a recommended midamble period in the next single subframe (MPDU or A-MSDU), or the next aggregate MPDU contained in a PPDU, recommending an increase in the number of recommended pilot tones (to better track phase and frequency drift worsened due to the Doppler effect), changing the pilot tone scheme (traveling pilots instead of fixed subcarriers pilots so as to more effectively re-estimate channel coefficients across multiple consecutively transmitted data symbols), using space time block coding (STBC) to leverage diversity to increase link robustness, reducing the number of spatial streams, and/or adjusting a frame size recommendation sent to STA A. If 318 is true, the method sets a recommended midamble period to a lower value to more frequently re-estimate the channel coefficients and CFO).

If 314 is false, the method determines whether midamble is present and one or more of course/fine CFO is less than a predetermined course/fine CFO threshold (CFO_{TH}), average PER (taken over a time-limited sliding window) is less than a predetermined PER threshold (PER_{TH2}), correlation of channel coefficients is higher than a threshold value (e.g., 0.5), and/or estimated channel coherence time is above a predetermined value. If 314 is true, the method recommends one or more of increasing a midamble period, increasing TXOP, increasing PPDU length, modifying pilot scheme (reduce number of pilot tones, stop traveling pilots, etc.), increasing the number of spatial streams, and/or adjusting any other possible PHY parameters that increase the goodput of the link. If the midamble period is at a maximum period, then having no midamble is recommended.

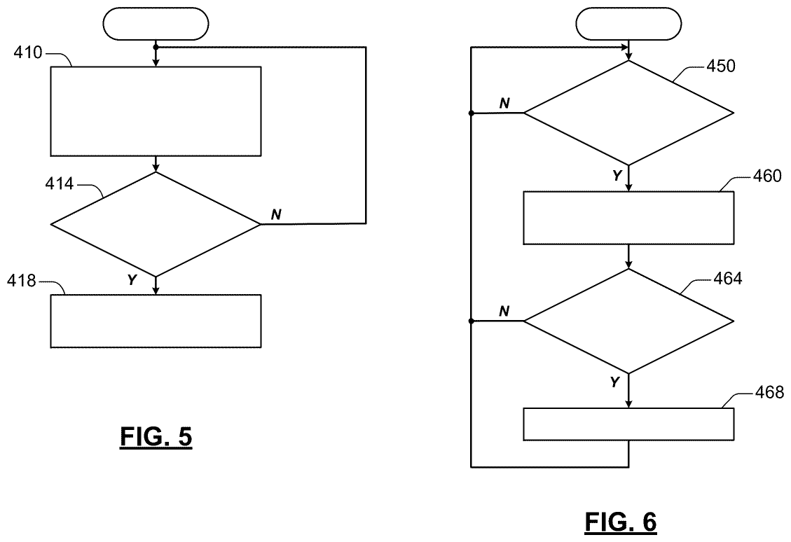

Referring now to FIG. 5, another method for performing link adaptation is shown. At 410, packet error rate (PER) and course/fine CFO (and/or other channel parameters) are measured at STA B for a PLCP protocol data unit (PPDU) received from STA A. At 414, the method determines whether PER is greater than a predetermined PER threshold (PER_{TH1}), rCFO is greater than a predetermined rCFO threshold (rCFO_{TH1}), and midamble is at a minimum period. If 414 is true, the method recommends increased null tone between consecutive data tones.

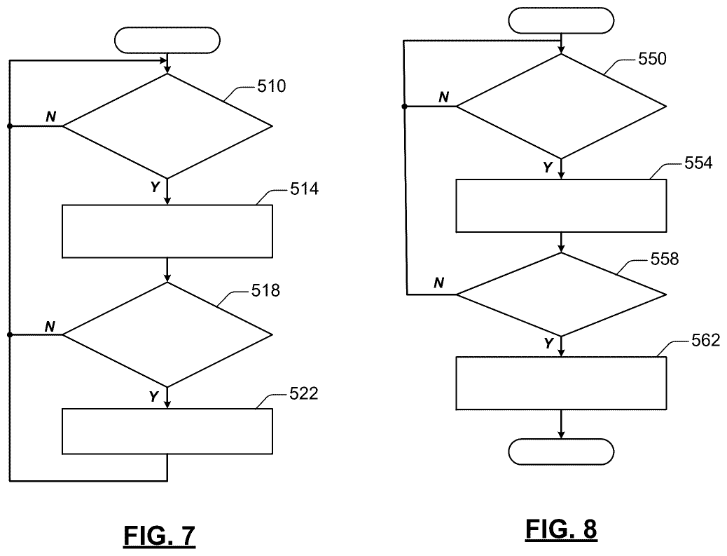

Referring now to FIG. 6, the method determines whether a midamble request and recommended period are received from STA B at 450. If 450 is true, STA A includes a midamble with the recommended period in PPDUs at 460. At 464, the method determines whether STA A has received an indication that the midamble is no longer needed. If 464 is true, STA A removes the midamble in the PPDUs at 468.

Referring now to FIG. 7, the method determines whether STA A receives a parameter change request from STA B at 510. If 510 is true, STA A selectively applies one or more of the recommended parameters at 514. At 518, the method determines whether STA A has received an indication that the recommended parameters are no longer needed. If 518 is true, STA A resets the configuration of its transmission parameters used for sending frames to STA B. For example, STA A removes the midamble in the PPDUs at 522. In other examples, STA A may reset the duration of TXOP, length of PPDU, or other parameters modified based on STA B's signal containing parameter recommendations, indication of high Doppler-based degradation, and/or transmitted channel coefficients (which is used by STA A to locally estimate channel coherence time and/or channel correlation).

Referring now to FIG. 8, the method determines whether STA A establishes a link with STA B at 550. If 550 is true, STA A configures Doppler-induced degradation mitigation parameters at 554 (based on signal received from STA B post association). At 558, STA A according to the method determines whether STA B is roaming from STA A (AP1) to STA C (AP3). If 558 is true, STA A transmits Doppler shift mitigation patterns established with STA B to STA C at 562. These parameters may be transmitted over the air, or possibly via a distributed system both STA A and STA C are part of (e.g., an Ethernet network both STA A and STA C are connected to).

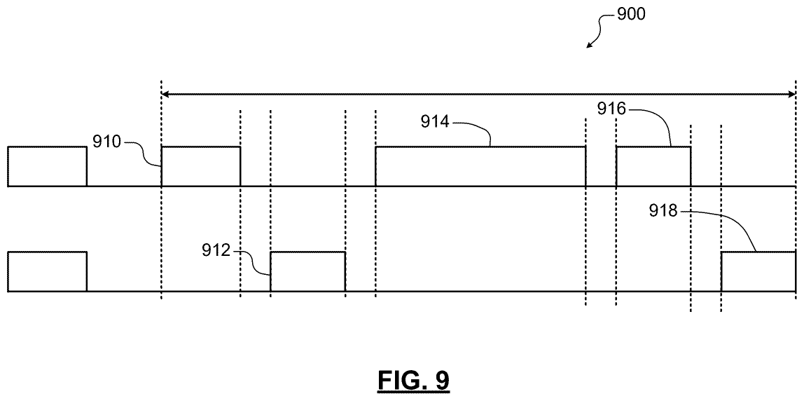

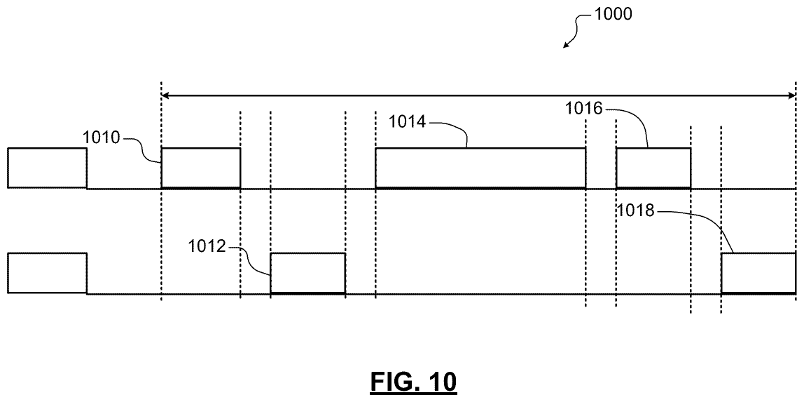

Referring now to FIGS. 9 and 10, a signaling method is disclosed to combat the challenges induced in the channel under Doppler effect. Specifically, in scenarios where mobility of the transmitter, receiver, and/or reflecting objects in the environment results in Doppler spread, coherence time of the channel can become very short. Coherence time is inversely proportional to maximum Doppler shift.

As noted above, with a short coherence time of a channel, the channel decorrelates very rapidly. Various methods of estimating coherence time using maximum Doppler shift are common based on different definitions and assumptions. In some examples, coherence time is estimated at 0.4 times inverse of max Doppler shift. In other examples, a multiplying factor different than 0.4 is used. For example, for a STA moving at 40 miles per hour and operating in 2.4 GHz, the maximum Doppler shift f_{D} is about 143 Hz, which corresponds to a coherence time of approximately 7 msec if the multiplying factor is 1, and 2.8 msec if the multiplying factor is 0.4. For example, for a STA moving at 40 miles per hour and operating in 5.8 GHz, the maximum Doppler shift f_{D}=345.7 Hz which corresponds to a coherence time of approximately 2.9 msec with a factor of 1, and 2.03 msec using a factor of 0.4.

Channel coefficients computed using a long training field (LTF) in the preamble become invalid after an amount of time greater than channel coherence time has elapsed after their computation. When transmitting PPDUs with a duration longer than the coherence time and without a midamble, this issue can cause severe impairment in the ability of the receiver to correctly retrieve transmitted data and accordingly results in a high PER.

Most current link adaptation approaches operating at a first WLAN STA (transmitting frames to a second WLAN STA) use a long sliding window (e.g., up to 1 second) of PER indications (inferred based on receipt or not receipt of individual or block ACKs from the second STA corresponding to the frames/subframes transmitted to the second STA) to modify transmission parameters. In a fast-decorrelating channel however, this feedback mechanism can be severely impeded, and even rendered ineffective, as the timescale of such feedback-based adaptation can be significantly larger than the channel coherence time. STAs according to the present disclosure are configured to use a transmitter-initiated channel measurement for link adaptation for transmitting data to high-mobility STAs as will be described further below.

In FIG. 9, method 900 for downlink data transmission for improved link adaptation for packet transmission to a high-mobility STA or a STA connecting to an AP in an environment which includes various moving scatterers which result in Doppler-induced degradation is shown. STA A (AP) may use the method 900 in response to Doppler-induced degradation (as a result of STA B being high-mobility, or the presence of mobile scatterers, refractors, and reflectors in the environment, such as a busy street). This determination may be a result of STA B sending a signal to STA A informing STA A of one or more pieces of information such as STA B's speed, acceleration, and/or direction of movement, STA B's estimated channel correlation over a sliding time window of a predetermined duration (for the channel between STA A and STA B in the downlink direction), STA B's estimated (obtained over a sliding window of time) channel coherence time (for the channel between STA A and STA B in the downlink direction), STA B's estimate of CFO and/or rCFO value exceeding a predetermined threshold (instantaneous value and its statistics over a sliding window of time).

The determination may further be user configured, or based on a characteristic of the operating environment in which STA A and B operate. For example, if STA A operates as a public access point (open access to all or restricted access) operating outdoors (where there are moving scatterers) and/or an access point which caters to vehicles (in streets, plants, manufacturing lots, dealerships), or to moving robots (in industrial or residential settings), STA A adopts this transmission method for sending data to STA B (which may be a vehicle). Similarly, if STA A identifies based on data indicated in signaling between STA A and STA B that STA B is a moving device (such as a vehicle or a robot), it may adopt method 900.

STA A (AP) selects a TXOP based on recent values of channel/channel variation, PER statistics, and Doppler shift/coherence time. The duration of the steps taken during method 900 is aimed to be within a TXOP (obtained by STA A) so that channel access contention is not required to be performed by STA A and STA B during performing the steps of method 900. The TXOP value is selected to match the estimated current channel coherence time. Note that if contention for channel access were needed (i.e., if the operations were not performed in one TXOP), the duration needed to complete these steps would have been variable, and potentially could exceed channel coherence time.

At 910, STA A sends a frame to STA B which also elicit a short PPDU from STA B to STA A at 912. The frame sent at 910 may include header and training data only (and no real payload), such as a null data packet. The frame at 910 may include a number of long training field (LTF) symbols, which may be transmitted at a regular transmit power of STA A (used for transmitting other frames) or with a boosted transmit power. Frame 910 may be transmitted following an announcement frame (not shown in FIG. 9) which intends to inform STA B and/or prepare it for receiving frame to be sent at 910.

The short PPDU sent at 912 may include one or more of instantaneous channel coefficients estimated using one or more LTFs sent to it at 910 by STA A. STA B may additionally or alternatively include recommended transmission values mentioned earlier with respect to FIGS. 3-8 for STA A to employ when transmitting frames to STA B.

In some examples, the short PPDU sent at 912 includes computed CFO, rCFO, error vector, PER, etc. that are calculated by STA B in response to the frame 910. In some examples, the short PPDU may also include other parameters such as vehicle speed, vehicle acceleration, and/or other data.

In some examples, the short PPDU sent at 912 has a “short” duration less than or equal to a predetermined fraction of the current coherence time of the channel between STA A and STA B. In some examples, the portion of the current coherence time is in a range from 10% to 30% (e.g., 20%). In some examples, the short PPDU includes MCS feedback recommendation information and a midamble recommendation to help the transmitter of STA A with selection of PHY parameters.

STA A (AP) uses LTFs and pilot data included in the short PPDU sent at 912 to estimate channel conditions, Doppler shift, coherence time, and/or other channel parameters. STA A (AP) uses the calculated parameters to determine new link adaptation parameters to mitigate Doppler-induced degradation. In some examples, other info shared in the short PPDU may also be used for the determination of PHY parameters of STA A.

At 914, STA A sends one or more PPDUs (which may each contain a single MPDU or be an A-MPDU containing subframes that are each A-MSDUs or single MPDUs). Then, at 916, STA A sends acknowledgement requests or a block acknowledgement request (BAR), in response to which STA B sends a block acknowledgement (BA) at 918. There could be more than one aggregate PPDU, BAR, and BA exchange sequence included in the TXOP obtained by STA A (not shown in the figure).

If packet aggregation and block ACK scheme is not used, there could be more than one PPDU and ack exchange. Also, add block ack (ADDBA) request/response sequence during which the number of subframes included in BA, and the acknowledgement scheme is agreed to by the two STAs communicating over WLAN may or may not be included in every realization of method 900 and is not shown in the figure. If there is an aggregate PPDU transmitted during a realization of method 900 and ADDBA exchange is not included in a realization of method 900, the number of subframes in a frame and other acknowledgement agreements may be based on a prior instance or a predetermined configuration (one or more recent previous rounds of full message exchange according to method 900).

In FIG. 10, a method 1000 for uplink data transmission for improved link adaptation for packet transmission from a high-mobility STA, or a STA connecting to an AP in an environment including various moving scatterers causing Doppler-induced degradation is shown. This method is mirror of method 900 (which is for improved transmission to a high-mobility STA B), but for the uplink direction (from STA B (non-AP) to STA A (AP)).

STA B (non-AP) may use the method 1000 in response to Doppler-induced degradation on the channel (as a result of STA B being high-mobility, or the presence of mobile scatterers, refractors, and reflectors in the environment, such as a busy street). This determination may be a result of STA B learning about its speed, acceleration, and/or direction of movement, STA B's receiving a signal from STA informing it of STA's estimated channel correlation, coherence time over a sliding time window of a predetermined duration, higher than a threshold CFO, higher than a threshold rCFO (for the channel between STA A and STA B in the uplink direction).

The determination may further be user configured, or based on a characteristic of the operating environment in which STA A and STA B operate. For example, if STA A operates as a public access point (open access to all or restricted access) operating outdoors (where there are moving scatterers) and/or an access point which caters to vehicles (in streets, plants, manufacturing lots, dealerships), or to moving robots (in industrial or residential settings), STA B (which may be a vehicle) adopts this transmission method for sending uplink data to STA A. Similarly, if STA A identifies based on data indicated in signaling between STA A and STA B that STA B is a moving device (such as a vehicle or a robot), it may recommend that STA B adopt the method 1000.

STA B contends for and obtains a TXOP whose duration is selected based on recent values of channel/channel variation, PER statistics, and Doppler shift/coherence time. The duration of the steps taken during method 1000 is aimed to be within a TXOP (obtained by STA B) so that channel access contention is not required to be performed by STA B and STA A during performing the steps of method 1000. The TXOP value is selected to match the estimated current channel coherence time. Note that if contention for channel access were needed (i.e., if the operations were not performed in one TXOP), the duration needed to complete these steps would have been variable, and potentially could exceed channel coherence time.

In 1010, STA B sends a frame to STA A which also elicit a short PPDU from STA A to STA B at 1012. The frame sent at 1010 may include header and training data only (and no real payload), such as a Null Data Packet. The frame at 1010 may include a number of Long Training Field (LTF) symbols, which may be transmitted at a regular transmit power of STA B (used for transmitting other frames) or with a boosted transmit power. Frame 1010 may be transmitted following an announcement frame (not shown in FIG. 10) which intends to inform STA A and/or prepare it for receiving frame to be sent at 1010.

The short PPDU sent at 1012 may include one or more of instantaneous channel coefficients estimated using one or more LTFs sent to it at 1010 by STA B. STA A may additionally or alternatively include recommended transmission values mentioned earlier with respect to FIGS. 3-8 for STA B to employ when transmitting uplink frames to STA A.

In some examples, the short PPDU sent at 1012 includes computed CFO, rCFO, error vector, PER, etc. that are calculated by STA A in response to the frame from STA B. In some examples, the short PPDU may also include other parameters such as vehicle speed, vehicle acceleration, and/or other data.

In some examples, the short PPDU sent at 1012 has a duration less than or equal to a predetermined fraction of the current coherence time of the uplink channel between STA B and STA A. In some examples, the fraction of the current coherence time is in a range from 10% to 30% (e.g., 20%). In some examples, the short PPDU includes MCS feedback recommendation information, and a midamble recommendation to help the transmitter of STA B with selection of PHY parameters.

STA B uses LTF(s) and pilot data included in short PPDU 1002 to estimate channel conditions, Doppler shift, coherence time, and/or other channel parameters. STA B uses the calculated parameters to determine new link adaptation parameters to mitigate Doppler induced degradations. In some examples, other info shared in the short PPDU sent in 1012 may also be used for the determination of PHY parameters of STA B.

In 1014, STA B sends one or more PPDUs (which may each contain a single MPDU or be an A-MPDU containing subframes that are each A-MSDUs or single MPDUs). At 1016, STA B sends acknowledgement requests or a block acknowledgement request (BAR), in response to which STA A sends a block acknowledgement (BA) at 1018. There could be more than one aggregate PPDU, BAR, and BA exchange sequence included in the TXOP obtained by STA A. If packet aggregation and block ACK scheme is not used, there could be more than one PPDU and ack exchange. Also, add block ack (ADDBA) request/response sequence during which the number of subframes included in BA, and the acknowledgement scheme is agreed to by the two STAs communicating over WLAN may or may not be included in every realization of method 1000 and is not shown in the figure. If there is an aggregate PPDU transmitted during a realization of method 1000 and ADDBA exchange is not included in a realization of method 1000, the number of subframes in a frame and other acknowledgement agreements may be based on a prior realization of method 1000 (one or more recent previous rounds of full message exchange according to method 1000) or a predetermined configuration.

In some examples, STA A (AP) may maintain a sliding window corresponding to frequency domain channel coefficients computed for multiple subcarriers (vector H), or time domain coefficients corresponding to different taps of channel impulse response and perform cross-correlation between multiple PPDUs (potentially some of them transmitted over multiple TXOPs). STA A estimates a mean coherence time and its standard deviation.

In both FIG. 9 and FIG. 10, SIFS as per 802.11 specification indicates short inter-frame spacing (SIFS), which is a small duration of time used as time delay between frames sent with the aim of performing immediate response actions.

In some examples, information based on the estimated mean and standard deviation of coherence time (and potentially its changing trend) known to a current AP is shared by the current AP with a target AP during the roaming process of a STA from the current AP to the target AP to improve handover operation's seamlessness and decrease traffic disruption.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A first network device comprising:
a physical layer module configured to transmit packets to and receive packets from a second network device via a wireless medium in a wireless local area network (WLAN),
wherein the first network device is moving at a speed greater than 3 km/hr relative to the second network device; and
a media access control (MAC) module including a link adaptation module configured to:
selectively identify Doppler-induced degradation in packets received from the second network device based on at least one of a packet error rate (PER), a carrier frequency offset (CFO), a residual CFO, and an indicator of low channel coherence time; and
in response to the identifying the Doppler-induced degradation, selectively send a first frame to the second network device including a recommended action to mitigate the Doppler-induced degradation.

2. The first network device of claim 1, wherein the recommended action includes adoption of one or more recommended parameters selected from a group consisting of:
a number of data symbols in a frame;
a request for midamble inclusion;
a midamble period;
a request for use of Space-Time Block Code (STBC);
a number of pilot tones in data symbol; and
a number of null tones interleaved between consecutive tones in a data symbol to reduce inter-carrier-interface.

3. The first network device of claim 1, wherein the first frame further comprises at least one of a velocity, direction, and acceleration of the first network device.

4. The first network device of claim 2, wherein the recommended action includes adoption of one or more recommended parameters consisting of an aggregate MAC protocol data unit (A-MPDU) size for the second network device.

5. The first network device of claim 2, wherein the recommended action includes adoption of one or more recommended parameters consisting of a transmission opportunity (TXOP) duration for the second network device.

6. The first network device of claim 1, wherein, the recommended action is for the second network device to send one or more frames to the first network device, wherein at least one of the one or more frames enables the first network device to estimate one or more parameters of a WLAN channel used by the second network device to send frames to the first network device.

7. The first network device of claim 6, wherein the one or more frames from the second network device include a second frame informing the first network device of a third frame.

8. The first network device of claim 7, wherein, the link adaptation module is further configured to, in response of receiving the third frame, generate a fourth frame including the one or more parameters of the WLAN channel, and send the fourth frame to the second network device after a short interframe spacing (SIFS) amount of time from receipt of the third frame.

9. The first network device of claim 1, wherein the link adaptation module is configured to detect the Doppler-induced degradation and to selectively generate the first frame with the recommended action in response to a request from the second network device.

10. The first network device of claim 1, wherein the device is physically integrated with hardware and software components of a vehicle.

11. A method for improving link adaptation between a first network device and a second network device, comprising:
selectively identifying Doppler-induced degradation in packets received from the second network device over a WLAN link established between the first network device and the second network device based on at least one of:
a velocity of motion of the first network device,
a packet error rate (PER),
a carrier frequency offset (CFO),
a residual CFO, and
an indicator of fast channel variation; and
in response to the identifying of Doppler-induced degradation, selectively sending a first frame to the second network device including a recommended action for the second network device to mitigate the Doppler-induced degradation.

12. The method of claim 11, wherein the recommended action includes adoption of one or more recommended parameters selected from a group consisting of:
a number of data symbols in a frame;
a request for midamble inclusion;
a midamble period;
a request for use of Space-Time Block Code (STBC);
a number of pilot tones in data symbol;
a transmission opportunity (TXOP) duration for transmitting frames to the second network device; and
a number of null tones interleaved between consecutive tones in a data symbol to reduce inter-carrier-interface.

13. The method of claim 11, wherein the recommended action includes a request for the second network device to send one or more frames to the first network device.

14. The method of claim 13, further comprising, in response to receiving at least one of the one or more frames, estimating one or more parameters of a WLAN channel used by the second network device to send frames to the first network device.

15. The method of claim 14, wherein the one or more frames from the second network device include a second frame informing the first network device of a third frame.

16. The method of claim 15, further comprising:
in response of receiving the third frame, generating a fourth frame including one or more parameters of the WLAN channel,
sending the fourth frame to the second network device after a short interframe spacing (SIFS) amount of time from receipt of the third frame, and
in response to sending the fourth frame, receiving one or more frames from the second network device,
wherein at least one of the one or more frames is sent using transmission parameters based at least in part on the one or more parameters of the WLAN channel included in the fourth frame.

17. The method of claim 16, wherein one of:
the first network device corresponds to a WLAN access point (AP) and the second network device is a non-access point WLAN Station moving at a speed greater than 3 km/hr relative to the first network device; and
the second network device corresponds to a WLAN access point (AP) and the first network device is moving at a speed greater than 3 km/hr relative to the second network device.

18. The method of claim 12, wherein:
the second network device is configured to, upon initiating a roaming process for the first network device to transition from having the WLAN link established to the second network device to establishing a WLAN link to a third network device, send one or more recommended parameters for mitigating Doppler-induced degradation to the third network device, and
wherein the one or more recommended parameters are selected from a group consisting of:
an indication of fast channel variation;
an estimated channel coherence time;
a number of data symbols in a frame;
inclusion of a midamble;
a midamble period;
inclusion of a Space-Time Block Code (STBC);
a number of pilot tones in data symbol;
a transmission opportunity (TXOP) duration; and
a number of null tones interleaved between consecutive tones in a data symbol.

19. A wireless network comprising:
a first network device; and
a second network device moving at a speed greater than 3 km/hr relative to the first network device,
wherein the first network device comprises:
a first physical layer module configured to transmit packets to and receive packets from a second network device via a wireless medium in a wireless local area network (WLAN) over a channel, wherein the second network device is moving relative to the first network device; and
a first media access control (MAC) module including a link adaptation module configured to receive at least one of a velocity of the second network device, receive one or more channel parameters estimated at the second network device, and receive one or more recommended transmission parameters selected from a group consisting of:
a number of data symbols in a frame,
inclusion of a midamble,
a midamble period,
inclusion of a space-time block code (STBC),
a number of pilot tones in data symbol,
a duration of a transmission opportunity (TXOP), and
a recommended number of null tones interleaved between consecutive tones in a data symbol to reduce inter-carrier-interface,
wherein the second network device comprises:
a second physical layer module configured to transmit packets to and receive packets from the first network device via the wireless medium in the WLAN over the channel; and
a second media access control device configured to determine the one or more recommended transmission parameters by generating one or more channel quality parameters based on the packets received from the first network device, wherein the one or more channel quality parameters are selected from a group consisting of:
channel coefficients estimated based on processing one or more training symbols,
a packet error rate (PER),
a fast channel variation indication,
a carrier frequency offset (CFO), and
a residual CFO (rCFO) from the second network device.

20. The wireless network of claim 19, wherein:
the first network device selectively transmits a frame to the second network device,
the frame is constructed based on a signal received from a third network device from which the second network device roamed from prior to establishing a WLAN link with the first network device,
the signal includes one or more of a velocity of the second network device, a channel parameter estimated at the second network device, and a recommended transmission parameter selected from a group consisting of a number of data symbols in a frame, inclusion of a midamble, a midamble period, use of a space-time block code (STBC), a number of pilot tones in data symbol, a duration of a transmission opportunity (TXOP), and a recommended number of null tones interleaved between consecutive tones in a data symbol to reduce inter-carrier-interface, and
wherein the third network device determined the recommended transmission parameter based on previous data exchanges with the second network device prior to the roaming.
